(19) United States
(12) Patent Application Publication
(10) Pub. No.: US 2025/0196589 A1
(43) Pub. Date: Jun. 19, 2025

(54) AIR REGISTER ASSEMBLY

(71) Applicant: Ford Global Technologies, LLC, Dearborn, MI (US)

(72) Inventor: Graham Lloyd Feltham, Canton, MI (US)

(73) Assignee: Ford Global Technologies, LLC, Dearborn, MI (US)

(21) Appl. No.: 18/545,101

(22) Filed: Dec. 19, 2023

(51) Int. Cl. B60H 1/34; B60H 1/00

(52) U.S. Cl. CPC B60H 1/3421; B60H 1/00664; B60H 2001/00721

(57) ABSTRACT

An air register assembly includes a control jet defining a first passage and a first chamber. The air register assembly includes a valve coupled with the control jet within the first chamber. The air register assembly includes a main jet spaced from the control jet, the main jet defining a second passage and second chamber. The first passage, the second passage, and the valve direct air on a first plane. The air register assembly includes a plurality of vanes pivotably coupled with the main jet within the second chamber. The plurality of vanes direct the air on a second plane different from the first plane.

### FIELD OF THE DISCLOSURE

The present disclosure generally relates to an air register assembly. More specifically, the present disclosure relates to an air register assembly for a vehicle, the air register assembly having a face plate that separates a main jet from a control jet.

### BACKGROUND OF THE DISCLOSURE

Occupants of a vehicle may appreciate a more elegant appearance for an air register. Accordingly, additional solutions are desired that provide the appearance and functionality of such a desired air register assembly.

### SUMMARY OF THE DISCLOSURE

According to a first aspect of the present disclosure, an air register assembly for a vehicle includes a control jet defining a first passage and a first chamber. The air register assembly includes a valve coupled with the control jet within the first chamber. The air register assembly includes a main jet spaced from the control jet, the main jet defining a second passage and second chamber. The first passage, the second passage, and the valve direct an air on a first plane. The air register assembly includes a plurality of vanes pivotably coupled with the main jet within the second chamber. The plurality of vanes direct the air on a second plane different from the first plane.

Embodiments of the first aspect of the present disclosure can include any one or a combination of the following features:
the control jet has a first internal cross-sectional area that is larger at the first chamber than the first passage, and wherein the main jet has a second internal cross-sectional area that is larger at the second chamber than at the second passage;
the second internal cross-sectional area is larger than the first internal cross-sectional area;
the valve rotates the first plane vertically, such that when the valve is fully open the air is directed lower than when the valve is closed;
the plurality of vanes rotate the second plane horizontally, such that the plurality of vanes pivot direct the air toward one of a first lateral side of the vehicle and a second lateral side of the vehicle;
the control jet directs the air downward, and wherein the main jet directs the air upward;
a face plate coupled with the control jet and the main jet and extending therebetween; and a rim coupled with the control jet and the main jet, wherein the air flows through the rim;
a slat coupled with the main jet, wherein the slat divides the main jet;
the slat is between the plurality of vanes and the rim; and
the slat reinforces where the main jet directs the air.

According to a second aspect of the present disclosure, an air register assembly includes a vent coupled with a heating, ventilation, and air conditioning unit. The air register assembly includes a control jet coupled with the vent, the control jet defining a first passage and a first bulbous chamber. An air exiting the control jet selectively flows downward. The air register assembly includes a valve coupled with the control jet, the valve positioned within the first chamber. The air register assembly includes a main jet coupled with the vent, the man jet defining a second passage and a second bulbous chamber, the main jet spaced from the control jet. The air exiting the main jet flows upward. The air exiting the control jet intersects the air exiting the main jet. The air register assembly includes a series of vanes pivotably coupled with the main jet, the series of vanes positioned within the second bulbous chamber. The air passing between the series of vanes flows toward one of a first lateral direction and a second lateral direction.

Embodiments of the second aspect of the present disclosure can include any one or a combination of the following features:
the valve selectively limits the air flowing through the control jet, such that the air exiting the main jet is uninterrupted when the valve is closed;
the first bulbous chamber is shaped to compensate for movement of the valve;
the second bulbous chamber is shaped to compensate for pivotal motion of the series of vanes;
a face plate extending between the control jet and the main jet where the air exits the control jet and the main jet, wherein a size of the face plate partially determines an angle of intersection between the air exiting the control jet and the air exiting the main jet, and wherein a shape of the face plate partially determines the angle of intersection between the air exiting the control jet and the air exiting the main jet; a slat coupled with the main jet, the slat in front of the series of vanes; and a rim coupled with the control jet and the main jet where the air exits the control jet and the main jet;
the control jet is concave toward the main jet between the first bulbous chamber and the rim, and wherein the control jet is convex toward the main jet at the first bulbous chamber;
the main jet is concave toward the control jet between the second bulbous chamber and the rim, and wherein the main jet is convex toward the control jet at the second bulbous chamber; and
the control jet has a first internal cross-sectional area, and wherein the main jet has a second internal cross-sectional area that is larger than the first internal cross-sectional area.

According to a third aspect of the present disclosure, a vehicle defining an interior cabin, the vehicle including a heating, ventilation, and air conditioning (HVAC) unit. The vehicle includes a vent fluidly coupled with the HVAC unit. The vehicle includes an air register assembly fluidly coupled with the vent. The air register assembly includes a control jet extending between the vent and the interior cabin. The control jet defines a first passage; and a first bulbous chamber. The air selectively flows through the first passage and the first bulbous chamber downwardly and outwardly toward the interior cabin. The air register assembly includes a valve coupled with the control jet, the valve positioned within the first bulbous chamber, the valve selectively limiting the air flowing through the first passage and the first bulbous chamber. The air register assembly includes a main jet spaced from the control jet, the main jet extending between the vent and the interior cabin. The main jet defines a second passage; and a second bulbous chamber. The air flows through the second passage and the second bulbous chamber upwardly and outwardly toward the interior cabin. The air register assembly includes at least one vane pivotably coupled with the main jet, the at least one vane positioned within the second bulbous chamber. The at least one vane directs the air toward one of a first lateral side and a second lateral side of the interior cabin.

Embodiments of the third aspect of the present disclosure can include the following features:
the air selectively flowing from the control jet intersects the air flowing from the main jet to redirect the air flowing from the main jet.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an interior cabin of a vehicle having an air register assembly;

FIG. 2 is a front perspective view of the air register assembly;

FIG. 3 is a front elevation view of the air register assembly;

FIG. 4A is a side elevation view of the air register assembly having a control jet that is closed;

FIG. 4B is a side elevation view of the air register assembly having the control jet that is open; and

FIG. 5 is a side elevation view of the air register assembly fluidly coupled with a heating, ventilation, and air conditioning unit.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

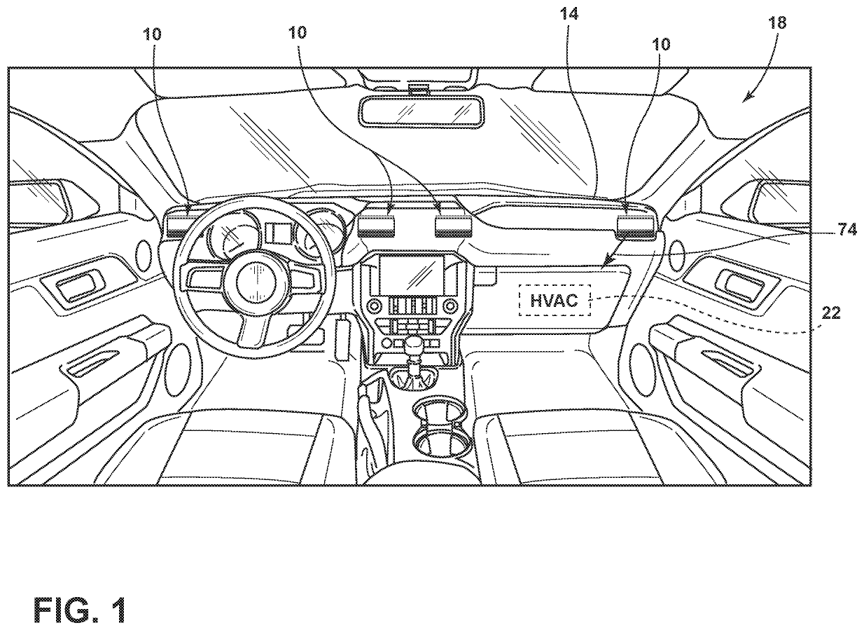

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an air register assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

With reference to FIG. 1, a motor vehicle 14 is illustrated having an interior cabin 18 generally configured with vehicle seating to accommodate a driver and passengers. A heating, ventilation, and air conditioning (HVAC) unit 22 is positioned within the vehicle 14 and coupled therein. The HVAC unit 22 circulates air 74 to the interior cabin 18. An air register assembly 10 is coupled with the vehicle 14 within the interior cabin 18. The air register assembly 10 is fluidly coupled with the HVAC unit 22. The air 74 travels between the HVAC unit 22 and the interior cabin 18. The air 74 passes through the air register assembly 10 before being delivered to the interior cabin 18.

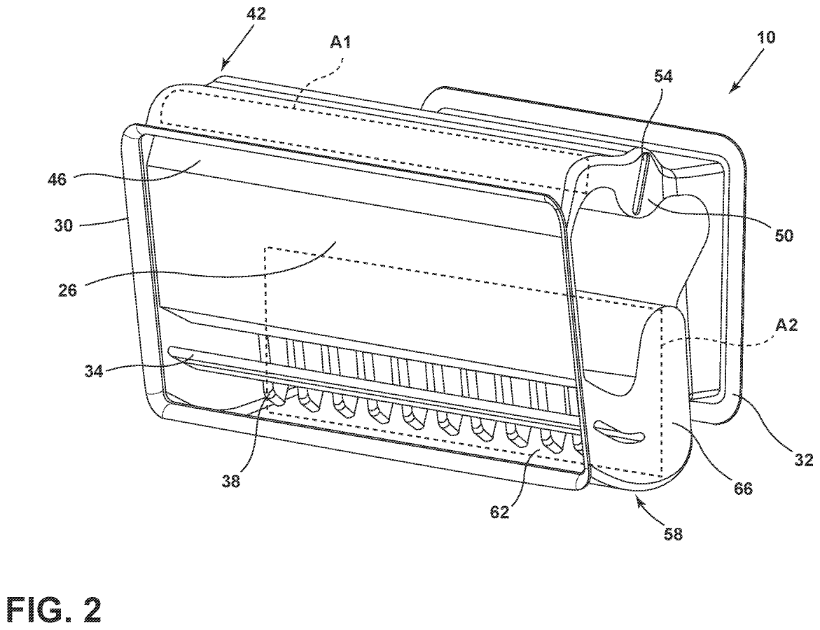

With reference to FIG. 2, the air register assembly 10 includes a rear periphery 32 and a rim 30 spaced from the rear periphery 32. The air register assembly 10 includes a control jet 42 coupled with the rear periphery 32 and the rim 30 and extending therebetween. The control jet 42 defines a first passage 46. The control jet 42 is curved concavely proximal to the rim 30. Additionally, or alternatively, the control jet 42 may be curved concavely proximal to the rear periphery 32. The control jet 42 defines a first chamber 50 along the first passage 46 between the rear periphery 32 and the rim 30. The control jet 42 is curved convexly at the first chamber 50 according to the illustrated embodiment.

With further reference to FIG. 2, the air register assembly 10 includes a valve 54 coupled with the control jet 42. The valve 54 is positioned within the first chamber 50. The valve 54 may be associated with rotational movement and/or translational movement to transition from an opened position to a closed position. For example, the valve 54 may be a butterfly valve, ball valve, pinch valve, or other type of valve. The first chamber 50 is shaped and sized to permit movement of the valve 54 to be opened, closed, and positioned therebetween. The control jet 42 has a first internal cross-sectional area A1. The first internal cross-sectional area Al may increase at the first chamber 50 to permit movement of the valve 54; therefore, the first chamber 50 may also be referred to as a first bulbous chamber. The first internal cross-sectional area A1 may decrease or increase depending on where along the first passage 46 the first internal cross-sectional area Al is measured. Therefore, the first internal cross-sectional area Al may also be considered variable.

With further reference to FIG. 2, the air register assembly 10 includes a main jet 58. The main jet 58, like the control jet 42, is coupled with the rear periphery 32 and the rim 30 and extending therebetween. The main jet 58 is in fluid communication with the control jet 42 proximal to the rear periphery 32. However, the main jet 58 is spaced from the control jet 42 proximal to the rim 30. The main jet 58 defines a second passage 62. The main jet 58 is curved concavely proximal to the rim 30. More specifically, the main jet 58 is curved concavely toward the control jet 42 between the rim 30 and the second chamber 66. The control jet 42 is curved concavely toward the main jet 58 between the rim 30 and the first chamber 50. Additionally, or alternatively, the main jet 58 may be curved concavely proximal to the rear periphery 32. More specifically, the main jet 58 may be curved concavely toward the control jet 42 between the rear periphery 32 and the second chamber 66. The control jet 42 is curved concavely toward the main jet 58 proximal to the rear periphery 32. The main jet 58 defines a second chamber 66 along the second passage 62 between the rear periphery 32 and the rim 30. The main jet 58 is curved convexly at the second chamber 66. More specifically, the main jet 58 is curved convexly at the second chamber 66 toward the control jet 42. The control jet 42 is curved convexly at the first chamber 50 toward the main jet 58.

With even further reference to FIG. 2, the air register assembly 10 includes a series of vanes 38 pivotably coupled with the main jet 58. The series of vanes 38 may also be referred to as a plurality of vanes and at least one vane. The series of vanes 38 is positioned within the second chamber 66. The second chamber 66 is shaped and sized to permit pivotal movement of the series of vanes 38. The main jet 58 has a second internal cross-sectional area A2. The second internal cross-sectional area A2 is generally greater than the first internal cross-sectional area A1. The second internal cross-sectional area A2 may increase at the second chamber 66 to permit pivotal movement of the series of vanes 38; therefore, the second chamber 66 may also be referred to as a second bulbous chamber. The second internal cross-sectional area A2 may decrease or increase along one or both dimensions (height and width) depending on where along the second passage 62 the second internal cross-sectional area A2 is measured. Therefore, the second internal cross-sectional area A2 may also be considered variable.

The air register assembly 10 is further shown having a slat 34 coupled with the main jet 58. The slat 34 may divide the second passage 62. For example, the slat 34 may bisect the second passage 62. The slat 34 may be positioned in front of the series of vanes 38. The slat 34 may be between the series of vanes 38 and the rim 30. The slat 34 may be contoured to be similar to how the main jet 58 curves between the second chamber 66 and the rim 30.

The air register assembly 10 also includes a face plate 26 coupled with the control jet 42 and the main jet 58. The face plate 26 spaces the control jet 42 from the main jet 58 proximal to the rim 30.

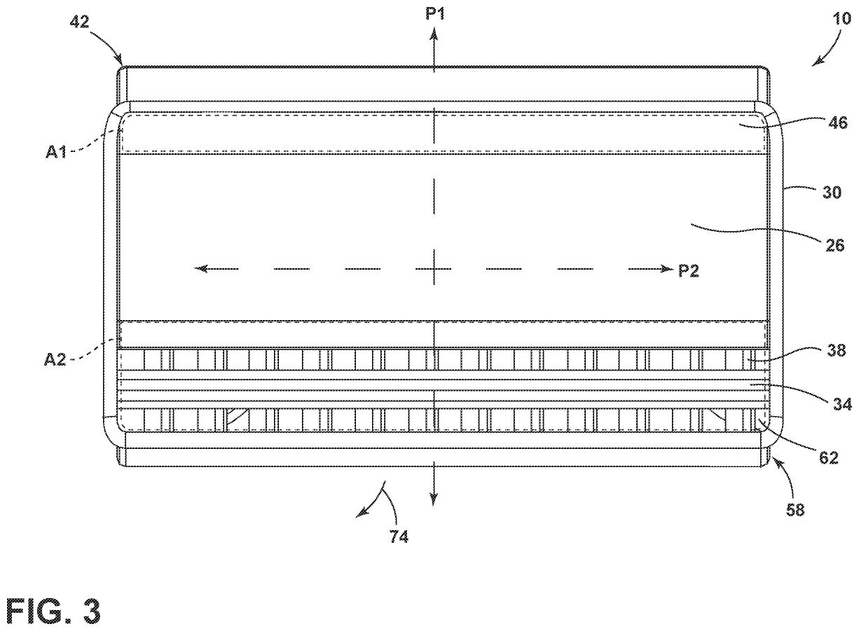

With reference to FIG. 3, the face plate 26 at least partially obscures the control jet 42 from a front perspective. The face plate 26 also at least partially obscures the main jet 58 from the front perspective. Due to the control jet 42 being curved, the first passage 46 is at least partially obscured from the front perspective such that first passage 46 can only partially be peered into. Due to the main jet 58 being curved, the second passage 62 is at least partially obscured from the front perspective such that the second passage 62 can only partially be peered into. Additionally, or alternatively, the control jet 42 may curve above the rim 30 from the front perspective. Additionally, or alternatively, the main jet 58 may curve below the rim 30 from the front perspective. Additionally, or alternatively, because the control jet 42 and the main jet 58 are curved, the Coanda effect reinforces where the air 74 is directed. Additionally, or alternatively, because the control jet 42 and the main jet 58 are curved, and because the air 74 flowing through the first passage 46 and the second passage 62 follow the Bernoulli Principle, pressure and speed of the air 74 are substantially unaffected. The slat 34 at least partially obscures the second passage 62 from the front perspective. The face plate 26 and the slat 34 obscure the series of vanes 38 from the front perspective. The rim 30 may flare outwardly from the face plate 26. Proximal to the rim 30, where the air 74 would exit the air register assembly 10, the first internal cross-sectional area A1 is less than the second internal cross-sectional area A2. For example, the first internal cross-sectional area A1 may be less than about two-thirds, about a half, about a third, or about a quarter of the second internal cross-sectional area A2.

With further reference to FIG. 3, the air 74 is directed vertically along a first plate P1. Further, the air 74 is directed laterally along a second plane P2. The first plane P1 is different from the second plane P2. For example, the first plane P1 is vertical, and the second plane P2 is horizontal. The air register assembly 10 may be installed, for example, to face the interior cabin 18 from a front of the vehicle 14, a rear of the vehicle 14, a lateral side of the vehicle 14, a floor of the vehicle 14, a ceiling of the vehicle 14, or a combination thereof. Therefore, the first plane P1 and the second plane P2 may be referred to as two chosen from lateral planes, vertical planes, horizontal planes, or diagonal planes. The vanes of the series of vanes 38 are parallel while static and while pivoting. The series of vanes 38 determines where the air 74 is directed laterally along the second plane P2. For example, the series of vanes 38 pivoted left may direct the air 74 to the left, and the series of vanes 38 pivoted right may direct the air 74 to the right. In other words, the series of vanes 38 directs the air 74 toward at least one of a first lateral side of the interior cabin 18, a second lateral side of the interior cabin 18, or somewhere between the first lateral side of the interior cabin 18 and the second lateral side of the interior cabin 18. In other words, the series of vanes 38 directs the air 74 toward at least one of a first lateral direction, a second lateral direction opposite the first lateral direction, or therebetween.

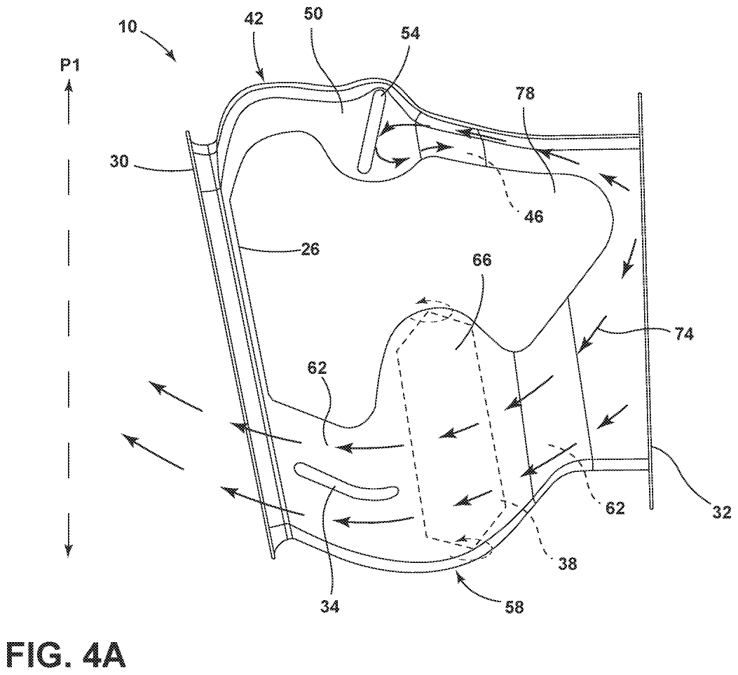

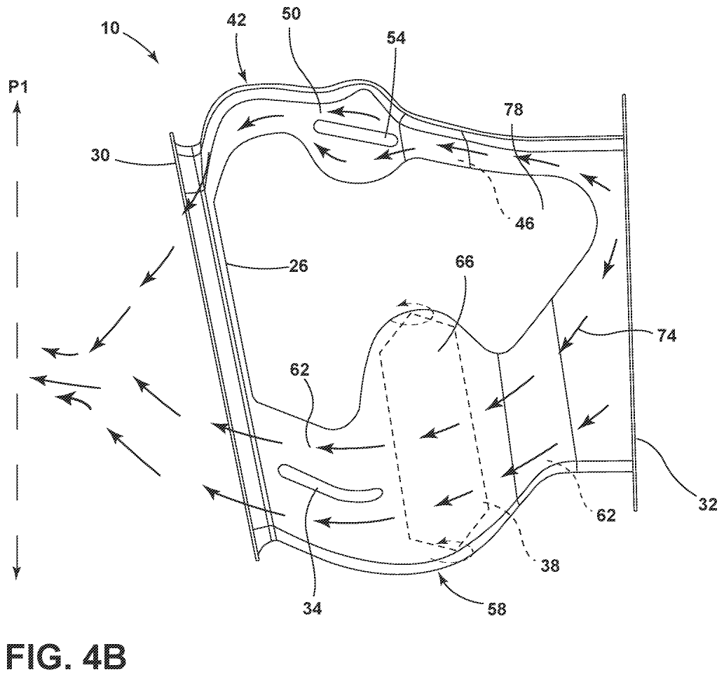

With reference to FIGS. 4A and 4B, the face plate 26, the control jet 42, and the main jet 58 define a cavity 78. The space within the cavity 78 from the side perspective is generally that of a rounded triangle with two missing humps on sides of the rounded triangle due to the first chamber 50 and the second chamber 66 protruding into the cavity 78. As shown in FIG. 3, the face plate 26 obscures the cavity 78 from the front perspective. The pivotal motion of the series of vanes 38 is shown by the dashed, curved arrows above and below the series of vanes 38.

With further reference to FIG. 4A, the air 74 flows into the first passage 46 between the rear periphery 32 and the valve 54 in the first chamber 50 while the valve 54 is in the closed position. While the valve 54 is closed, the air 74 does not flow past the valve 54 between the valve 54 and the rim 30. Therefore, the valve 54 selectively limits the air 74 flowing through the control jet 42. Additionally, or alternatively, while the valve 54 is closed, the air 74 flowing outwardly from the main jet 58 through the rim 30, is directed vertically up along the first plane P1 due to the main jet 58 being curved. Further, the air 74 that exits the main jet 58 while the vale 54 is closed, flows uninterrupted by the air 74 that would have exited the control jet 42 had the valve 54 been open. More specifically, the main jet 58 being curved concavely between the second chamber 66 and the rim 30 toward the control jet 42 directs the air 74 exiting the main jet 58 vertically up along the first plane P1. Additionally, or alternatively, the slat 34 reinforces the air 74 flowing from the second chamber 66 to the rim 30 to be directed vertically up along the first plane P1.

With further reference to FIG. 4B, the valve 54 is in the open position. While the valve 54 is open, the air 74 flows within the second passage 46 from the rear periphery 32 past the rim 30. The air 74 exiting the control jet 42 is directed vertically down along the first plane P1. The air 74 exiting the control jet 42 intersects the air 74 exiting the main jet 58 to redirect the air 74. The resulting air 74 is rejoined and flowing away from the air register assembly 10. The air 74 is directed along the first plane P1 higher than the air 74 was directed by the control jet 42 and lower than the air 74 was directed by the main jet 58. The valve 54 assists in how the air 74 exiting the control jet 42 affects the air 74 exiting the main jet 58. For example, if the valve 54 is open, the air 74 is directed further down along the first plane P1 than compared to if the valve 54 is partially open because there would be less air 74 flowing from the control jet 42. Additionally, or alternatively, the face plate 26 assists in how the air 74 exiting the control jet 42 affects the air 74 exiting the main jet 58. For example, if the face plate 26 is larger, the air 74 exiting the control jet 42 intersects the air 74 exiting the main jet 58 further from the air register assembly 10. Additionally, or alternatively, if the face plate 26 is shaped more convexly to permit the Coanda effect to drag the air 74 exiting the control jet 42 down and/or the air 74 exiting the main jet 58 up, the air 74 is rejoined closer to the air register assembly 10. In other words, an angle of intersection of the air 74 exiting the control jet 42 and the air 74 exiting the main jet 58 may be affected by at least one of a size of the face plate 26 and a shape of the face plate 26.

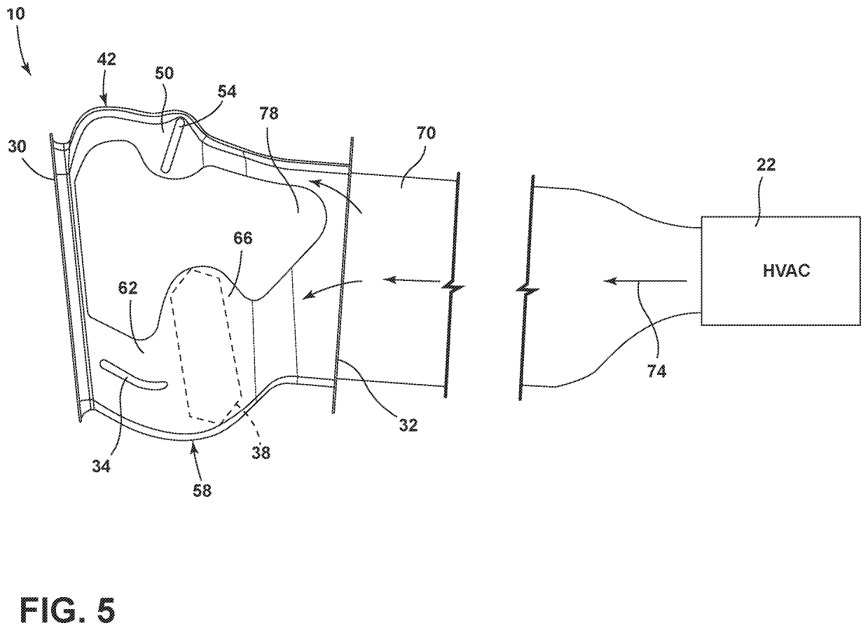

With reference to FIG. 5, the air register assembly 10 is fluidly coupled with a vent 70 at the rear periphery 32. The vent 70 is fluidly coupled with the HVAC unit 22, thus the air register assembly 10 is ultimately in fluid communication with the HVAC unit 22.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An air register assembly for a vehicle, the air register assembly comprising:
an control jet defining a first passage and a first chamber;
a valve coupled with the control jet within the first chamber;
a main jet spaced from the control jet, the main jet defining a second passage and second chamber, wherein the first passage, the second passage, and the valve direct air on a first plane; and
a plurality of vanes pivotably coupled with the main jet within the second chamber, wherein the plurality of vanes direct the air on a second plane different from the first plane.

2. The air register assembly of claim 1, wherein the control jet has a first internal cross-sectional area that is larger at the first chamber than the first passage, and wherein the main jet has a second internal cross-sectional area that is larger at the second chamber than at the second passage.

3. The air register assembly of claim 2, wherein the second internal cross-sectional area is larger than the first internal cross-sectional area.

4. The air register assembly of claim 1, wherein the valve vertically lowers the air directed along the first plane, such that when the valve is open the air is directed lower than when the valve is closed.

5. The air register assembly of claim 4, wherein the plurality of vanes horizontally shift the air along the second plane, such that the plurality of vanes pivot direct the air toward one of a first lateral side of the interior cabin and a second lateral side of the interior cabin.

6. The air register assembly of claim 4, wherein the control jet directs the air downward, and wherein the main jet directs the air upward.

7. The air register assembly of claim 1 further including:
a face plate coupled with the control jet and the main jet and extending therebetween; and
a rim coupled with the control jet and the main jet, wherein the air flows through the rim.

8. The air register assembly of claim 7 further including:
a slat coupled with the main jet, wherein the slat divides the main jet.

9. The air register assembly of claim 8, wherein the slat is between the plurality of vanes and the rim.

10. The air register assembly of claim 8, wherein the slat reinforces where the main jet directs the air.

11. An air register assembly comprising:
a vent coupled with a heating, ventilation, and air conditioning unit;
a control jet coupled with the vent, the control jet defining a first passage and a first bulbous chamber, wherein air exiting the control jet selectively flows vertically down;
a valve coupled with the control jet, the valve positioned within the first chamber;
a main jet coupled with the vent, the main jet defining a second passage and a second bulbous chamber, the main jet spaced from the control jet; wherein the air exiting the main jet flows vertically up, and wherein the air exiting the control jet intersects the air exiting the main jet; and
a series of vanes pivotably coupled with the main jet, the series of vanes positioned within the second bulbous chamber, wherein the air passing between the series of vanes flows toward one of a first lateral direction and a second lateral direction.

12. The air register assembly of claim 11, wherein the valve selectively limits the air flowing through the control jet, such that the air exiting the main jet is uninterrupted when the valve is closed.

13. The air register assembly of claim 11, wherein the first bulbous chamber is shaped to permit movement of the valve.

14. The air register assembly of claim 11, wherein the second bulbous chamber is shaped to permit pivotal motion of the series of vanes.

15. The air register assembly of claim 11 further including:
a face plate extending between the control jet and the main jet where the air exits the control jet and the main jet, wherein a size of the face plate partially determines an angle of intersection between the air exiting the control jet and the air exiting the main jet, and wherein a shape of the face plate partially determines the angle of intersection between the air exiting the control jet and the air exiting the main jet;
a slat coupled with the main jet, the slat in front of the series of vanes; and
a rim coupled with the control jet and the main jet where the air exits the control jet and the main jet.

16. The air register assembly of claim 15, wherein the control jet is concave toward the main jet between the first bulbous chamber and the rim, and wherein the control jet is convex toward the main jet at the first bulbous chamber.

17. The air register assembly of claim 15, wherein the main jet is concave toward the control jet between the second bulbous chamber and the rim, and wherein the main jet is convex toward the control jet at the second bulbous chamber.

18. The air register assembly of claim 11, wherein the control jet has a first internal cross-sectional area, and wherein the main jet has a second internal cross-sectional area that is larger than the first internal cross-sectional area.

19. A vehicle defining an interior cabin, the vehicle comprising:
a heating, ventilation, and air conditioning (HVAC) unit;
a vent fluidly coupled with the HVAC unit;
an air register assembly fluidly coupled with the vent, the air register assembly including:
a control jet extending between the vent and the interior cabin, the control jet defining:
a first passage; and
a first bulbous chamber, wherein air selectively flows through the first passage and the first bulbous chamber downwardly and outwardly toward the interior cabin;
a valve coupled with the control jet, the valve positioned within the first bulbous chamber, the valve selectively limiting the air flowing through the first passage and the first bulbous chamber;
a main jet spaced from the control jet, the main jet extending between the vent and the interior cabin, the main jet defining:
a second passage; and
a second bulbous chamber, wherein the air flows through the second passage and the second bulbous chamber upwardly and outwardly toward the interior cabin; and
at least one vane pivotably coupled with the main jet, the at least one vane positioned within the second bulbous chamber, wherein the at least one vane directs the air toward one of a first lateral side and a second lateral side of the interior cabin.

20. The vehicle of claim 19, wherein the air selectively flowing from the control jet intersects the air flowing from the main jet to redirect the air flowing from the main jet.
